(19) United States
(12) Patent Application Publication
(10) Pub. No.: US 2024/0376402 A1
(43) Pub. Date: Nov. 14, 2024

(54) ANTIMICROBIAL COMPOSITION AND THE FORMULATION COMPRISING THE SAME

(71) Applicant: SPECIALTY OPERATIONS FRANCE, Lyon (FR)

(72) Inventors: Sujandi Zhou, Singapore (SG); Galder Cristobal, Princeton, NJ (US); Wojciech Bzducha, Courbevoie (FR); David James Wilson, Coye-La-Forêt (FR)

(73) Assignee: SPECIALTY OPERATIONS FRANCE, Lyon (FR)

(21) Appl. No.: 18/690,059

(22) PCT Filed: Sep. 9, 2022
(86) PCT No.: PCT/EP2022/075129

§ 371 Date: Mar. 7, 2024

(30) Foreign Application Priority Data
Sep. 10, 2021 (WO) PCT/EP2021/075008

(51) Int. Cl. C11D 3/37; C11D 3/20; C11D 3/26; C11D 3/48

(52) U.S. Cl. CPC C11D 3/3719; C11D 3/2065; C11D 3/26; C11D 3/48; C11D 2111/12

(57) ABSTRACT

The present disclosure relates to an antimicrobial composition comprising a first antimicrobial agent selected from the group consisting of benzalkonium salts, Triclocarban, Diclosan, Triclosan, or the combination thereof; and a second antimicrobial agent which is the cationic polymer having a weight average molecular weight of 1,000 to 50,000 represented by general formula (I). The present disclosure further relates to a personal care composition comprising the same.

This application claims priority filed on 10 Sep. 2021 in INTERNATIONAL PROCEDURE with Nr EP2021/075008, the whole content of this application being incorporated herein by reference for all purposes.

### FIELD OF THE INVENTION

The present disclosure relates to an antimicrobial composition comprising an antimicrobial agent selected from the group consisting of halophenols, nitrophenols, bispenols, quaternary ammonium compounds or the combination thereof; and a cationic polymer having a weight average molecular weight of 1,000 to 50,000 represented by general formula I. The present disclosure further relates to a formulation composition comprising the same.

### BACKGROUND OF THE INVENTION

In recent years, as a result of the COVID-19 pandemic, the world is facing an unprecedented global health, social and economic emergency. At the same time, the accidents caused by a bacterium occurs frequently and a social problem has arisen. In order to deal with these problems, for example, an antimicrobial agent for imparting an antimicrobial property to a desired surface of a member, a fiber product or a resin product which has been subjected to an antimicrobial treatment by an antimicrobial agent in advance, and the like have been marketed.

Antimicrobial agents are chemical compositions that can be used in a solid block functional material to prevent microbial contamination and deterioration of commercial products material systems, surfaces, etc. Generally, these materials fall in specific classes including phenolics, halogen compounds, quaternary ammonium compounds, metal derivatives, amines, alkanol amines, nitro derivatives, organosulfur and sulfur-nitrogen compounds and miscellaneous compounds. The given antimicrobial agent depending on chemical composition and concentration may simply limit further proliferation of numbers of the microbe or may destroy all or a substantial proportion of the microbial population. The terms “microbes” and “microorganisms” typically refer primarily to bacteria and fungus microorganisms. In use, the antimicrobial agents are formed into a solid functional material that when diluted and dispensed using an aqueous stream forms an aqueous disinfectant or sanitizer composition that can be contacted with a variety of surfaces resulting in prevention of growth or the killing of a substantial proportion of the microbial population. Common antimicrobial agents include phenolic antimicrobials such as pentachlorophenol, orthophenylphenol. Halogen containing antibacterial agents include sodium trichloroisocyanurate, sodium dichloroisocyanurate (anhydrous or dihydrate), iodine-poly(vinylpyrolidinonen) complexes, bromine compounds such as 2-bromo-2-nitropropane-1,3-diol, quaternary antimicrobial agents such as benzalconium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their microbial properties

WO2011148950 discloses a cationic polymer antimicrobial agent which can be incorporated into personal care compositions, for example liquid detergent, liquid soaps etc.

However, as the higher requirement on disinfection, it is still favorable to develop antimicrobial agents with better microbicidal efficacy.

### SUMMARY OF THE INVENTION

It is surprisingly found by the inventors that the combination of the cationic polymer of the formula I and some antimicrobial agents can improve the antimicrobial performance and malodor controlling performance, as well as prolong the antimicrobial effect.

Therefore, in one aspect of the present disclosure, it is provided an antimicrobial composition comprising
a) an antimicrobial agent selected from the group consisting of halophenols, nitrophenols, bispenols, quaternary ammonium compounds or the combination thereof; and
b) a cationic polymer having a weight average molecular weight of 1,000 to 50,000 represented by the general formula I,

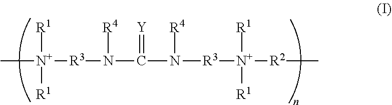

wherein
   R¹ represents a hydrogen atom, a C₁-C₄ alkyl group or hydroxyalkyl group, or a C₂-C₄ an alkenyl group;
   R² represents a C₄-C₈ oxyalkylene group represented by general formula (II) below;

—(CH₂)ₐ—(OR₅)_{b}—O(CH₂)ₐ— (II)
wherein R⁵ represents an alkylene group; a represents an integer ranging from 2 to 5; and b represents an integer ranging from 0 to 5;
   R³ represents a C₂-C₁₀ alkylene group;
   R⁴ represents a hydrogen atom, a C₁-C₄ alkyl group or hydroxyalkyl group, or a C₂-C₄ an alkenyl group;
   Y represents an oxygen atom or a sulfur atom;
   n represents an integer ranging from 2 to 150.

In another aspect of the present disclosure, it is provided a formulation comprising
i) the antimicrobial composition as illustrated above; and
ii) an adjuvant selected from
   iia) a surfactant selected from cationic surfactant, anionic surfactant, non-ionic surfactant, amphoteric surfactant or the combination thereof; and/or
   iib) a thickening agent.

In one embodiment of the present disclosure, the formulation is a homecare formation or personal care formulation, preferably, the formulation is a product of disinfectant, all-purpose cleaner, laundry detergent, dishwashing liquid, deodorant, fabric conditioner, product for disinfection and sanitization of hard surfaces, floor cleaner, glass cleaner, kitchen cleaner, bath cleaner, sanitary cleaner, hygiene rinse product for fabrics, carpet cleaner, furniture cleaner, or a product for conditioning, sealing, caring or treating hard and soft surfaces; or for the manufacture of a personal care formulation, especially a deodorant, skin care preparation, bath preparation, cosmetic care preparation, foot-care preparation, light-protective preparation, skin-tanning preparation, depigmenting preparation, insect-repellent, antiperspirant, preparation for cleansing and caring for blemished skin, hair-removal preparation, shaving preparation, fragrance preparation, cosmetic hair-treatment preparation, antidandruff preparation, oral care composition.

### FIGURES

FIG. 1A shows the antibacterial fabric test results for Staphylococcus aureus (ATCC 6538) species.

FIG. 1B shows the antibacterial fabric test results for Klebsiella pneumonia (ATCC 4352) species.

FIG. 2 shown the Sirius Red Dye Adsorption by treated cotton fabric.

### DETAILED DESCRIPTION OF THE INVENTION

Throughout the description, including the claims, the term “comprising one” or “comprising a” should be understood as being synonymous with the term “comprising at least one”, unless otherwise specified. The terms “between” and “from . . . to . . . ” should be understood as being inclusive of the limits.

The articles “a”, “an” and “the” are used to refer to one or to more than one (i.e., to at least one) of the grammatical object of the article.

It should be noted that in specifying any range of concentration, weight ratio or amount, any particular upper concentration, weight ratio or amount can be associated with any particular lower concentration, weight ratio or amount, respectively.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the terminology “(Cn-Cm)” in reference to an organic group, wherein n and m are each integers, indicates that the group may contain from n carbon atoms to m carbon atoms per group.

As used herein, the term “hydroxyalkyl” means an alkyl radical, which is substituted with a hydroxyl groups, such as hydroxymethyl, hydroxyethyl, hydroxypropyl, and hydroxydecyl.

In one aspect of the present disclosure, it is provided an antimicrobial composition comprising:
a) an antimicrobial agent selected from the group consisting of halophenols, nitrophenols, bispenols, quaternary ammonium compounds or the combination thereof; and
b) a cationic polymer having a weight average molecular weight of 1,000 to 50,000 represented by general formula I,

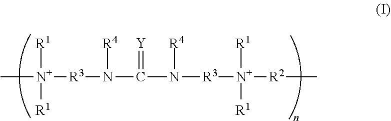

wherein
R¹ represents a hydrogen atom, a C₁-C₄ alkyl group or hydroxyalkyl group, or a C₂-C₄ an alkenyl group;
R² represents an C₄-C₈ oxyalkylene group represented by general formula (II) below;

—(CH₂)ₐ—(OR₅)_{b}—O(CH₂)ₐ— (II)
wherein R⁵ represents an alkylene group; a represents an integer ranging from 2 to 5; and b represents an integer ranging from 0 to 5;
R³ represents a C₂-C₁₀ alkylene group;
R⁴ represents a hydrogen atom, a C₁-C₄ alkyl group or hydroxyalkyl group, or a C₂-C₄ an alkenyl group;
Y represents an oxygen atom or a sulfur atom;
n represents an integer ranging from 2 to 150.

In the present disclosure, the antimicrobial agent is selected from selected from the group consisting of halophenols, nitrophenols, bispenols, quaternary ammonium compounds or the combination thereof.

The antimicrobial agents of the halophenols, nitrophenols, bispenols, quaternary ammonium compounds are the well-known in the art, the introduction thereof can be found in “Principles and Practice of Disinfection, Preservation & Sterilization” (Fourth Edition), which is incorporated by reference herein in its entirety.

As used herein, the term “halophenol” is used in its generic sense to refer to compositions that include a phenol or phenol derivative, and a halogen attached to the phenol or phenol derivative. The phenol can be derivatized with a water solubilizing group, bulky group, or other desired group to achieve a desired effect. Typically, the halogen, e.g., chloro or bromo group, is attached directly to the aromatic ring of the phenol.

As used herein, the term “nitro phenol” is used in its generic sense to refer to phenols having at least one nitro group (NO₂—) directly bonded to a carbon which is part of an benzene ring.

As used herein, the term “bisphenol” is used in its generic sense to refer to a compound comprising two phenol groups joined by one-atom bridge, such as an ether or thioether bridge. One or both phenols may be further substituted with one or more substituents, such as a polar group, a hydrophobic group, a hydrogen bond donor, or a hydrogen bond acceptor. The atom of the one-atom bridge may be further substituted with one or more substituents (e.g., —CO—, —SO—, —SO₂—, —CH₂—, etc.).

As used herein, the term “quaternary ammonium compounds” (QACs) refers to compounds in which at least one nitrogen atom is joined to four organic radicals leaving a net positive charge. In certain aspects, the organic radicals can be alkyl or alkenyl (unsaturated alkyls) groups that are linear or branched, substituted or unsubstituted, or mixtures thereof.

In one embodiment of the present disclosure, the halophenol is the one or more selected from 2,4,6-Trichlorophenol, Pentachlorophenol (2-phenylphenoxide), dichloroxylenol (dichloro-meta-xylenol; DCMX), 4-Chloro-3-methylphenol (chlorocresol), 4-Chloro-3,5-dimethylphenol (chloroxylenol; para-chloro-metaxylenol; PCMX), 4-Chloro-3-methylphenol (para-chlorometa-cresol; PCMC), Monochloro-2-phenylphenol, 2-Benzyl-4-chlorophenol (chlorphen; ortho-benzyl-para-chlorophenol; OBPCP). The nitrophenol is the one or more selected from 3,5-dinitro-o-cresol, 4-nitrophenol. The bispheonol is the one or more selected from dihydroxydiphenylmethane, hydroxydiphenylether, diphenylsulphide or the derivatives thereof. The quaternary ammonium compound is the one or more selected from centrimide, domiphen, benzethonium, benzalkonium, cetylpyridinium, preferably the halide salts thereof.

In one embodiment of the present disclosure, the antimicrobial agent is selected from benzalkonium chloride (BKC).

In another embodiment of the present disclosure, the antimicrobial agent is selected from Diclosan, Triclosan, Triclocarban or the combination thereof, preferably selected from Triclosan.

The cationic polymer having a weight average molecular weight of 1,000 to 50,000 represented by general formula I,

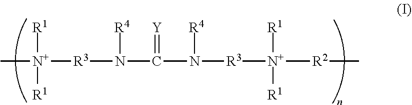

wherein
R¹ represents a hydrogen atom, a C₁-C₄ alkyl group or hydroxyalkyl group, or a C₂-C₄ an alkenyl group;
R² represents an C₄-C₈ oxyalkylene group represented by general formula (II) below;

—(CH₂)ₐ—(OR₅)_{b}—O(CH₂)ₐ— (II)
wherein R⁵ represents an alkylene group; a represents an integer ranging from 2 to 5; and b represents an integer ranging from 0 to 5;
R³ represents a C₂-C₁₀ alkylene group;
R⁴ represents a hydrogen atom, a C₁-C₄ alkyl group or hydroxyalkyl group, or a C₂-C₄ an alkenyl group;
Y represents an oxygen atom or a sulfur atom;
n represents an integer ranging from 2 to 150.

In one embodiment of the present disclosure, in the general formula I,
R¹ represents a C₁-C₄ alkyl group, preferably methyl, ethyl, propyl or butyl;
R³ represents a C₂-C₃ alkylene group;
R⁴ represents a hydrogen atom, or C₁-C₄ alkyl group, preferably H, methyl, ethyl, propyl or butyl; and
Y represents an oxygen atom.

In one embodiment of the present disclosure, the cationic polymer is represented by the formula III,

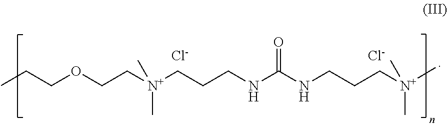

In one embodiment of the present disclosure, the weight ratio of the antimicrobial agent to the cationic polymer is in the range from 0.01 to 100, preferably from 0.01 to 10.

In another aspect of the present disclosure, it is provided a formulation comprising:
i) the antimicrobial composition as illustrated above; and
ii) an adjuvant selected from
   iia) a surfactant selected from cationic surfactant, anionic surfactant, non-ionic surfactant, amphoteric surfactant or the combination thereof; and/or
   iib) a thickening agent.

The formulation of the present disclosure comprising an antimicrobial composition is suitable for a variety of consumer applications.

In one embodiment of the present disclosure, the formulation is a homecare formation or personal care formulation. Examples of the formulations of the invention include, but are not limited to, surface cleaners such as those intended for use in bathrooms, kitchens, living areas, hard floor cleaners, carpet cleaners, furniture cleaners, glass/mirror cleaners; toilet care products including solid toilet cleaners such as rim devices and those designed to be placed in the cistern, liquid toilet cleaners excluding those comprising hypochlorite bleaches; dishwashing products such as washing up liquids and preparations from dishwashing machines such as dishwashing solids (e.g. powders and tablets) & liquids; laundry products such as solid detergents (e.g. powders and tablets), liquid detergents and fabric conditioners and “2 in 1” products comprising detergent and fabric conditioner; cleaning products intended for use outdoors such as those for cleaning for wood, stone, concrete or plastics, for example patio cleaner, garden furniture cleaners/treatments, BBQ cleaners, wall and fence cleaners/treatments, plant sprays such as those intended to remove insects such as aphides from plants; food sprays, such as those suitable for use in food preservation; personal care products such as bath and shower products; soaps, including liquid and solid soaps, hand sanitizers, deodorants and antiperspirants, haircare products including shampoos, for example anti-scalp odour shampoos, shampoos for the control of head lice eggs and antidandruff shampoos, hair conditioners, hair styling products such as hair mousses, gels and sprays, skin care products such as shaving products, cosmetics and products for hair removal; baby products including baby cleaning and cleansing products such as baby bath, soaps, wipes, moisturizers, nappy rash cream, products for cleaning surfaces that have regular & high incidence of infant & baby contact; first aid products and products for treating ailments and illnesses, including products for the topical treatment and/or prevention of minor infections such as athletes foot, spot/acne prevention/treatment products; foot hygiene products, including those for use on the foot and those for the treatment/deodorization of foot ware, particularly sports foot wear; products for cleaning and/or deodorizing vehicles such as cars.

In one aspect of the present disclosure, the formulation is a laundry detergent composition, comprising
i) the antimicrobial composition as illustrated above; and
ii) a surfactant selected from cationic surfactant, anionic surfactant, non-ionic surfactant, amphoteric surfactant or the combination thereof.

The laundry detergent composition can be in a form of liquid or solid.

Suitable non-ionic surfactants for use as the formulation surfactant include but are not limited to ethylene oxide/propylene oxide block polymers, polyethoxylated sorbitan esters, fatty esters of sorbitan, ethoxylated fatty esters (containing from 1 to 25 units of ethylene oxide), polyethoxylated C8-C22 alcohols (containing from 1 to 25 units of ethylene oxide), polyethyoxylated C6-C22 alkylphenols (containing from 5 to 25 units of ethylene oxide), alkylpolyglycosides. Examples include but are not limited to nonyl phenol ethoxylate (9EO), Nonyl phenol ethoxylate (2EO), octyl phenol ethoxylate (10EO), C12/C14 synthetic ethoxylate (8EO), stearyl alcohol ethoxylate (7EO), cetostearyl alcohol ethoxylate (20EO), coconut fatty amine ethoxylate (10EO), sorbitan monolaurate ethoxylate, 80% PO/20% EO, coconut diethanolamide (shampoo foam booster), sorbitan monolaurate, sorbitan monolaurate 4EO, di-isopropyl adipate, alkyl poly glucosides, such as C6-20, preferably C8-10 alkyl glucosides, eg Surfac APG (D-Glucopyranose oligomers C8-10 alkyl glucosides, CAS 161074-97-1, available from Seppic, UK), and cetostearyl stearate. Other suitable non-ionic surfactants include Neodol 25-7 (C12/15 alcohol 7 ethoxylate (EO), CAS 68131-39-5), Surfac LM90/85 (C12/15 alcohol 9 ethoxylate (EO), CAS 68131-39-5), Surfac 65/95 (C9/11 alcohol 6.5 ethoxylate (EO), CAS 68439-45-2), Tomadol PF9 (C9/11 alcohol 6.0 ethoxylate (EO), CAS 68439-46-3), Surfac T80 Veg (Polysorbate 80, Polyoxyethylene sorbate mono oleate, CAS 9005-65-6), Tween 60 (Polysorbate 60, Polyoxyethylene sorbate mono stearate, CAS 9005-67-8), Tween 40 (Polysorbate 40, Polyoxyethylene sorbate mono palmitate, CAS 9005-66-7), Surfac T-20 (Polysorbate 20, Polyoxyethylene sorbate mono laurate, CAS 9005-64-5), Surfac PGHC (Hydrogenated Castor oil 40EO, CAS 61788-85-0), Ninol 49-CE (Coconut diethanolamide, CAS 68603-42-9).

The anionic surfactants contemplated in the present disclosure as surface-active agent comprise the major active components in conventional detergent systems, including any of the known hydrophobes attached to a carboxylate, sulphonate, sulfate or phosphate polar, solubilizing group including salts. Salts may be the sodium, potassium, ammonium and amine salts of such surfactants. Useful anionic surface-active agents can be organic sulfuric reaction products having in their molecular structure an alkyl group containing from about 8 to about 22 carbon atoms and a sulfonic acid or sulfuric acid ester group, or mixtures thereof. (Included in the term “alkyl” is the alkyl portion of acyl groups.) Examples of this group of synthetic detersive surfactants which can be used in the present disclosure are the alkyl sulfates, especially those obtained by sulfating the higher alcohols (C₈-C₁₈ carbon atoms) produced from the glycerides of tallow or coconut oil; and alkyl benzene sulphonates.

Other useful anionic surface-active agents herein include the esters of alpha-sulphonated fatty acids preferably containing from about 6 to 20 carbon atoms in the ester group; 2-acyloxyalkane-1-sulfonic acids preferably containing from about 2 to 9 carbon atoms in the acyl group and from about 9 to about 23 carbon atoms in the alkane moiety; alkyl ether sulfates preferably containing from about 10 to 20 carbon atoms in the alkyl group and from about 1 to 30 moles of ethylene oxide; olefin sulphonates preferably containing from about 12 to 24 carbon atoms; and beta-alkyloxy alkane sulphonates preferably containing from about 1 to 3 carbon atoms in the alkyl group and from about 8 to 20 carbon atoms in the alkane moiety.

Specific preferred anionics for use herein include: the linear C₁₀-C₁₄ alkyl benzene sulphonates (LAS); the branched C₁₀-C₁₄ alkyl benzene sulphonates (ABS); the tallow alkyl sulfates, the coconut alkyl glyceryl ether sulphonates; the sulfated condensation products of mixed C₁₀-C₁₈ tallow alcohols with from about 1 to about 14 moles of ethylene oxide; and the mixtures of higher fatty acids containing from 10 to 18 carbon atoms.

It is to be recognized that any of the foregoing anionic surfactants can be used separately herein or as mixtures. Moreover, commercial grades of the surfactants can contain non-interfering components which are processing by-products. For example, commercial alkaryl sulphonates, preferably C₁₀-C₁₄, can comprise alkyl benzene sulphonates, alkyl toluene sulphonates, alkyl naphthalene sulphonates and alkyl poly-benzenoid sulphonates. Such materials and mixtures thereof are fully contemplated for use herein.

In another aspect of the present disclosure, the formulation is a sanitizer composition, comprising
i) the antimicrobial composition as illustrated above; and
ii) a thickening agent.

Preferred thickening agents used in the formulation of the present disclosure are commercially available fully synthetic thickeners based on acrylic acid copolymers, methacrylic acid copolymers, vinyl polymers, polycarboxylic acids, polyimines, polyamides and polyethers. In addition, natural thickening agents such as guars, carboxymethylcelluloses, cellulose ethers, xanthans, locust bean gum may be used, which are optionally modified by suitable chemical reactions, possibly even in view of their specific use in connection with the present disclosure. The foregoing components may be used either alone or in combinations thereof.

Illustrative examples of commercially available thickeners is a polymeric thickening agent sold under the name Jaguar HP105, distributed by Solvay.

In yet another aspect of the present disclosure, it is provided the use of the antimicrobial composition as illustrated above for substantially reducing or controlling the formation of microbial colonies on or at the surface.

In still another aspect of the present disclosure, it is provided the use of the antimicrobial composition as illustrated above for controlling malodor.

In still another aspect of the present disclosure, it is provided a process of preparing the formulation as illustrated above, comprising the steps of adding an antimicrobial composition to the formulation, wherein the antimicrobial composition comprises:
a) an antimicrobial agent selected from the group consisting of halophenols, nitrophenols, bispenols, quaternary ammonium compounds or the combination thereof; and
b) a cationic polymer having a weight average molecular weight of 1,000 to 50,000 represented by general formula I,

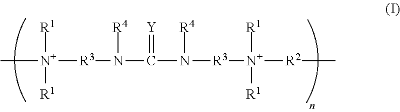

wherein
   R¹ represents a hydrogen atom, a C₁-C₄ alkyl group or hydroxyalkyl group, or a C₂-C₄ an alkenyl group;
   R² represents an C₄-C₈ oxyalkylene group represented by general formula (II) below;

—(CH₂)ₐ—(OR₅)_{b}—O(CH₂)ₐ— (II)
wherein R⁵ represents an alkylene group; a represents an integer ranging from 2 to 5; and b represents an integer ranging from 0 to 5;
   R³ represents a C₂-C₁₀ alkylene group;
   R⁴ represents a hydrogen atom, a C₁-C₄ alkyl group or hydroxyalkyl group, or a C₂-C₄ an alkenyl group;
   Y represents an oxygen atom or a sulfur atom;
   n represents an integer ranging from 2 to 150.

Should the disclosure of any patents, patent applications, and publications which are incorporated herein by reference conflict with the description of the present application to the extent that it may render a term unclear, the present description shall take precedence

### Examples

### Materials

Polyquaternium-2, CAS: 68555-36-2, available from Solvay under the tradename of Mirapol A15;
Benzalkonium Chloride: antimicrobial agent, commercial available;
Rhodasurf L7/90: Nonionic surfactant, available from Solvay;
Rhodapex ESB70: Anionic surfactant, available from Solvay;
Triclosan: antimicrobial agent, available form Aldrich.
W-10A: cotton fabric, available from wfk Testgewebe GmbH;

### 1. Laundry Detergent Composition

The components in the table on were mixed to for a homogenous mixture. The following examples were obtained.

In the following text, CS refers to the comparative examples, S refers to the example of the present invention

TABLE 1
the liquid detergent compositions

| Ingredient | | | |
|---|---|---|---|
| Active, % wt/wt | CS 1 | CS 2 | S 1 |
| Rhodasurf L7/90 | 15 | 15 | 15 |
| Rhodapex ESB70 | 9 | 9 | 9 |
| Coco fatty acid | 3 | 3 | 3 |
| Propylene glycol | 6.5 | 6.5 | 6.5 |
| NaOH, 40% | To pH 7.5 | To pH 7.5 | To pH 7.5 |
| Polyquaternium-2 | 1.3 | 0 | 1.3 |
| Triclosan | 0 | 0.1 | 0.1 |
| Water | To 100% | To 100% | To 100% |
| pH | 7.5 | 7.5 | 7.5 |

### 1.b Antimicrobial Performance

Standard cotton fabric (W-10A) was washed with LaunderOmeter® (SDLATLAS) with the detergent composition according to the Comparative Example 1 and 2 and Example 1. The detergent dosage is 5 gram per liter. The volume of the washing liquor is 500 ml. Fabric to liquor ratio (wt/wt) is 1 to 10. Singapore tap water with maximum hardness of 150 ppm was used as the water source. The laundry was done at temperature of 40 degree centigrade for 30 minutes. In each Launder Ometer® pot, 50 pieces steel balls was added. After the laundry, the fabrics were rinse twice with Singapore tab water for 1 minute each. Finally the fabrics were line-dried at temperature 22 degree centigrade with humidity of 60%.

The washed and dried fabrics were cut into square swatches with size of 3.8×3.8±0.1 cm. The number of swatches needed for the test is equal to 1.0±0.1 gram. Two bacteria strains i.e. Staphylococcus aureus (ATCC 6538) and Klebsiella pneumonia (ATCC 4352) were used for the test. The detail test was done according to the protocol AATCC TM 100-2019 which is available online via https://members.aatcc.org/store/tm100/513/.

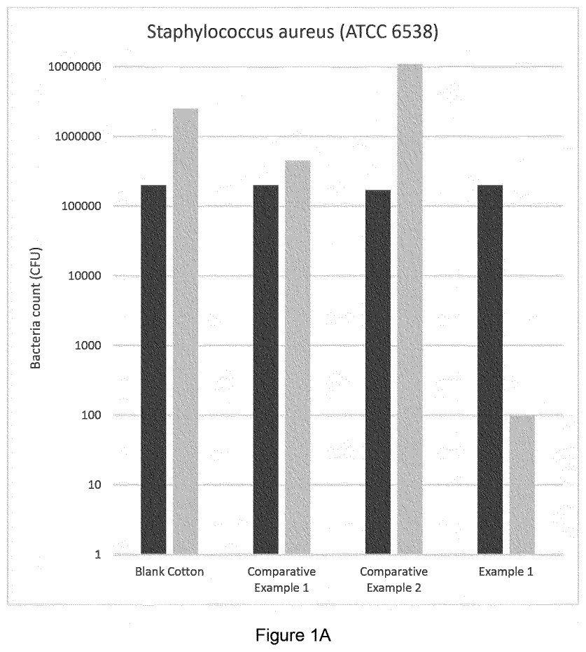

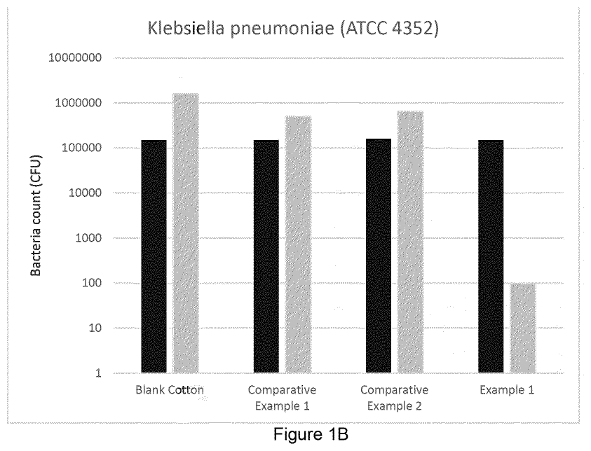

The test results were shown in the FIGS. 1A and 1B, wherein the left (black) pillar refers to at 0 hour contact time, the right (grey) pillar refers to 24 hours contact time.

FIG. 1A shows the antibacterial fabric test results for Staphylococcus aureus (ATCC 6538) species. The blank cotton, fabrics washed with detergents according to the comparative Examples 1 and 2 do not show any bacterial counts reduction. On the other hand, the fabric washed with detergent according to Example 3 which contains both Mirapol A15 and Triclosan active show bacterial count reduction of higher than 4.40 log with respect to the number of bacteria recovered from the inoculated untreated test specimen swatches which is the blank cotton.

FIG. 1B shows the antibacterial fabric test results for Klebsiella pneumonia (ATCC 4352) species. The blank cotton, fabrics washed with detergents according to Examples 1 and 2 do not show any bacterial counts reduction. On the other hand, the fabric washed with detergent according to Example 1 (which contains both Polyquaternium-2 and Triclosan) shows bacterial count reduction of higher than 4.20 log with respect to the number of bacteria recovered from the inoculated untreated test specimen swatches (which is the blank cotton).

### 2. Laundry Sanitizer Composition

The laundry sanitizer compositions were prepared by mixing the components listed in table 2 below.

Standard cotton fabric was washed with launder-Ometer from SDLATLAS with the detergent composition. The detergent dosage was 5 gram per liter. The volume of the washing liquor is 500 ml. Fabric to liquor ratio (wt/wt) is 1 to 10. Singapore tap water with maximum hardness of 150 ppm was used as the water source. The laundry was done at temperature of 40 degree centigrade for 30 minutes. In each launder-Ometer pot, 50 pieces steel balls was added. After the laundry, the fabrics were rinsed twice with Singapore tab water for 1 minute each. After completed the two rinse cycles, the fabrics were rinsed one more time with 500 ml tap water containing laundry sanitizer compositions according to examples 2 to 6. The laundry sanitizer dosage was 5 gram per liter. The rinsing was done at temperature of 40 degree centigrade for 30 minutes. In each launder-Ometer pot, 50 pieces steel balls was added. After completed the rinsing step with laundry sanitizer, the fabrics were spin dry at 1200 rpm with front load washing machine and then line-dried at temperature 22 degree centigrade with humidity of 60%.

TABLE 2
the sanitizer compositions

| Ingredient | | | | | | | |
|---|---|---|---|---|---|---|---|
| Active, % | | | | | | | |
| wt/wt | CS3 | CS4 | S2 | S3 | S4 | S5 | S6 |
| Polyquaternium-2 | 0 | 0 | 1.0% | 2.0% | 1.0% | 2.0% | 2.50% |
| Benzalkonium | 0 | 1.3% | 1.0% | 1.0% | 2.5% | 2.5% | 2.5% |
| Chloride | | | | | | | |
| Water | To | To | To | To | To | To | To |
| | 100% | 100% | 100% | 100% | 100% | 100% | 100% |
| pH | 7.5 | 7.5 | 7.5 | 7.5 | 7.5 | 7.5 | 7.5 |

Soak the 1.5 gram fabric in 100 mL Sirius Red dye solution (6.25 ppm) for 30 min with continuous shaking at 200 rpm, then measure the amount of Sirius dye adsorbed per gram fabric using UV-vis spectrophotometer at 528 nm.

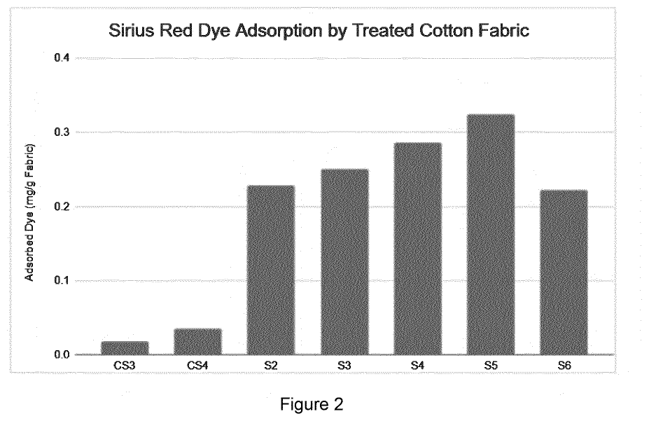

As shown in FIG. 2, the cationic polymer can significantly enhance the absorption of BKC on fabric surface, thus prolong the antimicrobial effect.

1. An antimicrobial composition comprising:
a) an antimicrobial agent selected from the group consisting of halophenols, nitrophenols, bisphenols, quaternary ammonium compounds or the combination thereof; and
b) a cationic polymer having a weight average molecular weight of 1,000 to 50,000 represented by the general formula I, 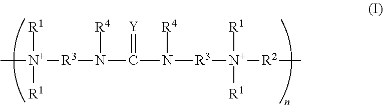
wherein
R¹ represents a hydrogen atom, a C₁-C₄ alkyl group or hydroxyalkyl group, or a C₂-C₄ an alkenyl group;
R² represents a C₄-C₈ oxyalkylene group represented by general formula (II) below;
—(CH₂)ₐ—(OR₅)_{b}—O(CH₂)ₐ— (II)
wherein R⁵ represents an alkylene group; a represents an integer ranging from 2 to 5; and b represents an integer ranging from 0 to 5;
R³ represents a C₂-C₁₀ alkylene group;
R⁴ represents a hydrogen atom, a C₁-C₄ alkyl group or hydroxyalkyl group, or a C₂-C₄ an alkenyl group;
Y represents an oxygen atom or a sulfur atom; and
n represents an integer ranging from 2 to 150.

2. The antimicrobial composition according to claim 1, wherein the halophenol is selected from 2,4,6-Trichlorophenol, Pentachlorophenol (2-phenylphenoxide), dichloroxylenol (DCMX), 4-Chloro-3-methylphenol (chlorocresol), 4-Chloro-3,5-dimethylphenol (PCMX), 4-Chloro-3-methylphenol (PCMC), monochloro-2-phenylphenol, 2-benzyl-4-chlorophenol (OBPCP) or the combination thereof.

3. The antimicrobial composition according to claim 1, wherein the nitrophenol is selected from 3,5-dinitro-o-cresol, 4-nitrophenol or the combination thereof.

4. The antimicrobial composition according to claim 1, wherein the bisphenol is selected from dihydroxydiphenylmethane, hydroxydiphenylether, diphenylsulphide or the derivatives thereof, or the combination thereof.

5. The antimicrobial composition according to claim 1, wherein the quaternary ammonium compound is selected from centrimide, domiphen, benzethonium, benzalkonium, cetylpyridinium or the combination thereof.

6. The antimicrobial composition according to claim 1, wherein the antimicrobial agent is selected from benzalkonium halide, Diclosan, Triclosan, Triclocarban or the combination thereof.

7. The antimicrobial composition according to claim 1, wherein
R¹ represents a C₁-C₄ alkyl group;
R³ represents a C₂-C₃ alkylene group;
R⁴ represents a hydrogen atom or C₁-C₄ alkyl group; and
Y represents an oxygen atom.

8. The antimicrobial composition according to claim 7, wherein the cationic polymer is selected from the compound represented by the formula III,

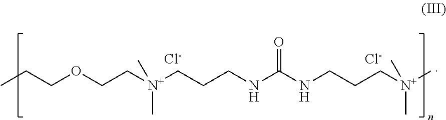

9. A formulation comprising:
i) the antimicrobial composition according to claim 1; and
ii) an adjuvant selected from:
iia) a surfactant selected from cationic surfactant, anionic surfactant, non-ionic surfactant, amphoteric surfactant or the combination thereof; and/or
iib) a thickening agent.

10. The formulation according to claim 9, wherein the formulation is a homecare formation or personal care formulation.

11. The formulation according to claim 9, wherein the formulation is a disinfectant, all purpose cleaner, laundry detergent, dishwashing liquid, deodorant, fabric conditioner, product for disinfection and sanitization of hard surfaces, floor cleaner, glass cleaner, kitchen cleaner, bath cleaner, sanitary cleaner, hygiene rinse product for fabrics, carpet cleaner, furniture cleaner, or a product for conditioning, sealing, caring or treating hard and soft surfaces; or for the manufacture of a personal care formulation, such as a deodorant, skin care preparation, bath preparation, cosmetic care preparation, foot-care preparation, light-protective preparation, skin-tanning preparation, depigmenting preparation, insect-repellent, antiperspirant, preparation for cleansing and caring for blemished skin, hair-removal preparation, shaving preparation, fragrance preparation, cosmetic hair-treatment preparation, antidandruff preparation, or oral care composition.

12. A laundry detergent composition, comprising:
i) the antimicrobial composition according to claim 1; and
ii) a surfactant selected from cationic surfactant, anionic surfactant, non-ionic surfactant, amphoteric surfactant or the combination thereof.

13. A sanitizer composition, comprising:
i) the antimicrobial composition according to claim 1; and
ii) a thickening agent.

14. A method of substantially reducing or controlling the formation of microbial colonies on or at a surface, by applying the antimicrobial composition according to claim 1 to the surface.

15. A method of preparing the formulation according to claim 9, comprising the steps of adding an antimicrobial composition to the formulation, wherein the antimicrobial composition comprises:
a) an antimicrobial agent selected from the group consisting of halophenols, nitrophenols, bisphenols, quaternary ammonium compounds or the combination thereof;
b) a cationic polymer having a weight average molecular weight of 1,000 to 50,000 represented by general formula I, 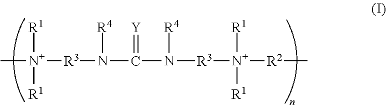
wherein
R¹ represents a hydrogen atom, a C₁-C₄ alkyl group or hydroxyalkyl group, or a C₂-C₄ an alkenyl group;
R² represents an C₄-C₈ oxyalkylene group represented by general formula (II) below;
—(CH₂)ₐ—(OR₅)_{b}—O(CH₂)ₐ— (II)
wherein R⁵ represents an alkylene group; a represents an integer ranging from 2 to 5; and b represents an integer ranging from 0 to 5;
R³ represents a C₂-C₁₀ alkylene group;
R⁴ represents a hydrogen atom, a C₁-C₄ alkyl group or hydroxyalkyl group, or a C₂-C₄ an alkenyl group;
Y represents an oxygen atom or a sulfur atom; and
n represents an integer ranging from 2 to 150.
